(19) United States
(12) Patent Application Publication
(10) Pub. No.: US 2010/0116684 A1
(43) Pub. Date: May 13, 2010

(54) WIND TO HYDROGEN ENERGY CONVERSION

(75) Inventor: Carleton E. Sawyer, Louden, NH (US)

Correspondence Address: MCDERMOTT WILL & EMERY LLP, 28 STATE STREET, BOSTON, MA, 02109-1775, US

(73) Assignee: Mr. Carleton E. Sawyer, Louden, NH (US)

(21) Appl. No.: 12/578,067

(22) Filed: Oct. 13, 2009

Related U.S. Application Data
(60) Provisional application No. 61/195,766, filed on Oct. 10, 2008.

(51) Int. Cl. C25B 1/04; F03D 9/00; B63B 35/00; B63B 1/10; C25B 9/00

(52) U.S. Cl. 205/628; 290/55; 114/65 R; 114/61.1; 204/242; 204/275.1

(57) ABSTRACT

Vessel-deployed wind machines are described that supply electricity for the electrolysis of sea water or fresh water to obtain hydrogen. The hydrogen produced from the electrolysis can be stored and used as desired. Hydrogen so produced can be used to power the vessel that carries the wind machines. Hydrogen produced can also be used for hydrogen fuel distribution networks and power plants.

### RELATED APPLICATION

This application claims the benefit of U.S. Provisional Patent Application No. 61/195,766, entitled “Wind to Hydrogen,” filed 10 Oct. 2008, the entire contents of which are incorporated herein by reference.

### BACKGROUND

As fossil fuel supplies decline and fossil fuel combustion byproducts continue to be a source of air pollution, a renewed emphasis is being placed on so-called traditional alternative energy sources such as wind, solar, and geothermal resources. While each of these alternative energy resources has advantages relative to fossil fuels, each also has drawbacks.

One surprising drawback of wind energy is the reluctance of land owners owning land within the line of sight of planed wind farms. Apparently, these land owners, while generally supportive of the use and development of non-fossil-fuel based energy sources, are never the less unwilling to have farms of windmills impeding their view of the landscape or seascape.

As an example, there presently is an on-going battle to build a windmill farm in the shallows south of Cape Cod on the coast of Massachusetts. The residents of the adjacent areas have complained that the rotating blades on the horizon would impact their view. They have also maintained that the rotating turbine blades would prove to be a hazard to bird life. While this latter point is generally true of wind farms, wind mills themselves are not believed to pose any more risk to birds than a building of equal size, and actually can pose less of a risk as birds can often pass right through the swept area of the windmill blades, when the timing is right. As an example of the powerful influence that such landowners have, the referenced wind farm project has been put on hold as a result of the worried landowners' actions in court.

Thus, a need exists to implement alternative energy resources such as wind energy in ways that are not disruptive to established communities.

### SUMMARY

Aspects and embodiments of the present disclosure address the shortcomings noted previously by implementing vessel-deployed wind machines that supply electricity for the electrolysis of sea water or fresh water to obtain hydrogen. The hydrogen produced from the electrolysis can be stored and used as desired. Hydrogen so produced can be used to power the vessel that carries the wind machines. Hydrogen produced can also be used for hydrogen fuel distribution networks and power plants.

Other features and advantages of the present disclosure will be understood upon reading and understanding the detailed description of exemplary embodiments, described herein, in conjunction with reference to the drawings.

### BRIEF DESCRIPTION OF THE DRAWINGS

Aspects of the present disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings:

FIG. 1 depicts a schematic view of a vessel-deployed wind-to-hydrogen system in accordance with an exemplary embodiment of the present disclosure;

FIG. depicts a side view of an electrolysis tank, in accordance with exemplary embodiments of the present disclosure;

FIG. 3 includes FIGS. 3A and 3B, which together depict a hydrogen storage container for storing hydrogen gas collected from electrolysis, in accordance with exemplary embodiments of the present disclosure; and

FIG. 4 depicts a block diagram of a method of converting wind energy to hydrogen fuel, in accordance with exemplary embodiments of the present disclosure.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION

As described previously, embodiments of the present disclosure are directed to implementing vessel-deployed wind machines that supply electricity for the electrolysis of sea water or fresh water to obtain hydrogen. The hydrogen produced can be stored and used for multiple purposes, e.g., for fueling power plants, supplying fuel to hydrogen vehicle fuel distribution networks, and the like.

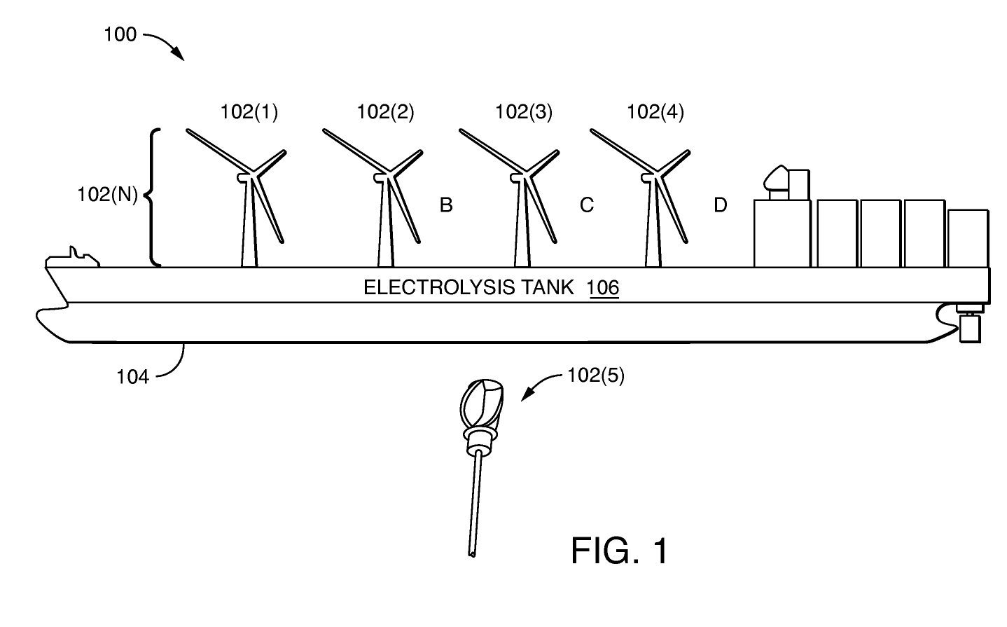

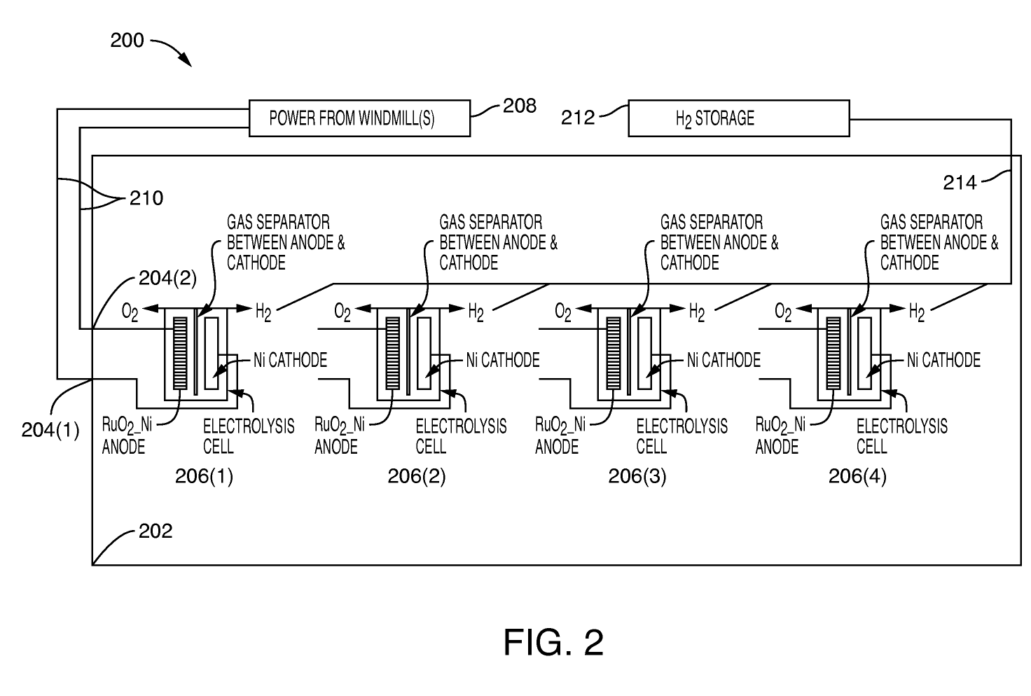

FIG. 1 depicts a schematic view of a vessel-deployed wind-to-hydrogen system 100 in accordance with an exemplary embodiment of the present disclosure. As shown, a number of suitable wind mills or wind machines 102(N), e.g., wind machines 102(1)-(4), can be placed on a suitable ship or vessel 104 for deployment at sea. The wind machines can include turbines with attached blades that rotate about a desired axis (e.g., vertical or horizontal). The turbines can have a desired number of blades or vanes. The vessel 104 can include a specialized tank 106 for the electrolysis of water. The water can be conveniently obtained from the surrounding water (ocean or fresh water).

Exemplary embodiments can include a ship 104 designed to hold several relatively large wind machines. Suitable examples of such wind machines can include vertical-axis machines built by Wind Energy Corporation of Elizabethtown, Ky. USA. An example of such is indicated by wind machine 102(5) in FIG. 1. Horizontal-axis wind machines may used in addition to or substitution for vertical-axis wind machines.

Exemplary wind machines as currently built by Wind Energy Systems are approximately twenty feet tall and have a footprint of a circle twelve feet in diameter, with a screw-type blade system that rotates along a vertical axis. Such machines are capable of generating fifty kilowatts of electrical power. In further exemplary embodiment, such machines can be scaled in size by a factor of four or so could allow for electricity production of up to megawatt or power. An array of twenty of these machines could produce a total of twenty Mega Watts. A large specially designed ship (e.g., ship 104 of FIG. 1) could hold at least that many. Thus, depending on the power output needed, ship 104 and wind machines 102(N) can be scaled as necessary.

In exemplary embodiments, the ship 104 could be designed somewhat like a catamaran with a very large deck connecting the two hulls. A single-hull ship could be less expensive while providing similar carrying capabilities. In exemplary embodiments, the carrier ship itself can be powered by an electric motor that would be powered by the electricity from the wind machines. A bank of batteries can be installed to supply stability during the rare moments when there is no wind. The one or more wind machines can fitted with or include direct current generators or suitable rectification systems so as to be able to produce direct current suitable for an electrolysis of water in tank 106, as described in further detail for FIG. 2.

FIG. 2 depicts a side view of an electrolysis tank 200, according to exemplary embodiments of the present disclosure. Such a tank is depicted with ship 104 in FIG. 1. Tank 200 can include a surface 202 for holding water (e.g., a bottom made of Lucite® or other synthetic resin or plastic) through which water tight terminals 204(1)-(2) can be connected to multiple pairs of electrolysis plates, which can act as cathodes and anodes, e.g., plate pairs 206(1)-(4), located in the inside of the tank 200. The pairs of electrolysis plates can be connected to the windmills and receive electricity (shown by power from the windmills 208) for driving the electrolysis process.

In operation, when the tank 200 is filled with water (e.g., sea water) and direct current is applied between the plates, hydrogen will form at one plate and oxygen at the other. The plate that is collecting hydrogen can fitted with a cone or other collection structure/device, e.g., a hose 214 so that the hydrogen can be directed where desired, e.g., as depicted by storage tank 212. The oxygen can be bled off or collected in a similar fashion. Many such sets of plates can be used, as needed. The tank 200 can be relatively shallow and can be partitioned off into many cells. Each cell can include a set of electrolysis plates. Each cell can be enclosed by a barrier (e.g., rectangular) for ensuring/facilitating that the plates are kept immersed when the roll of the ship would tend to slosh the water from one side of the tank to the other. Exemplary embodiments can utilize cells and plates as described in U.S. Pat. No. 7,510,640, the entire contents of which are incorporated herein by reference.

The water level in the tank 200 can be somewhat deeper that the cell barriers, in exemplary embodiments. When the water moves due to the roll of the ship, e.g., ship 104, the water in a cell would be constantly refreshed. There can be an optimum salt concentration of the water in the tank. As electrolysis proceeds the water will become more salt concentrated until the optimum is reached. At that point more sea water is added and/or brine is drained off so that the optimum is maintained. In exemplary embodiments, suitable electrolytes (sodium chloride or others) can be added to facilitate electrolysis.

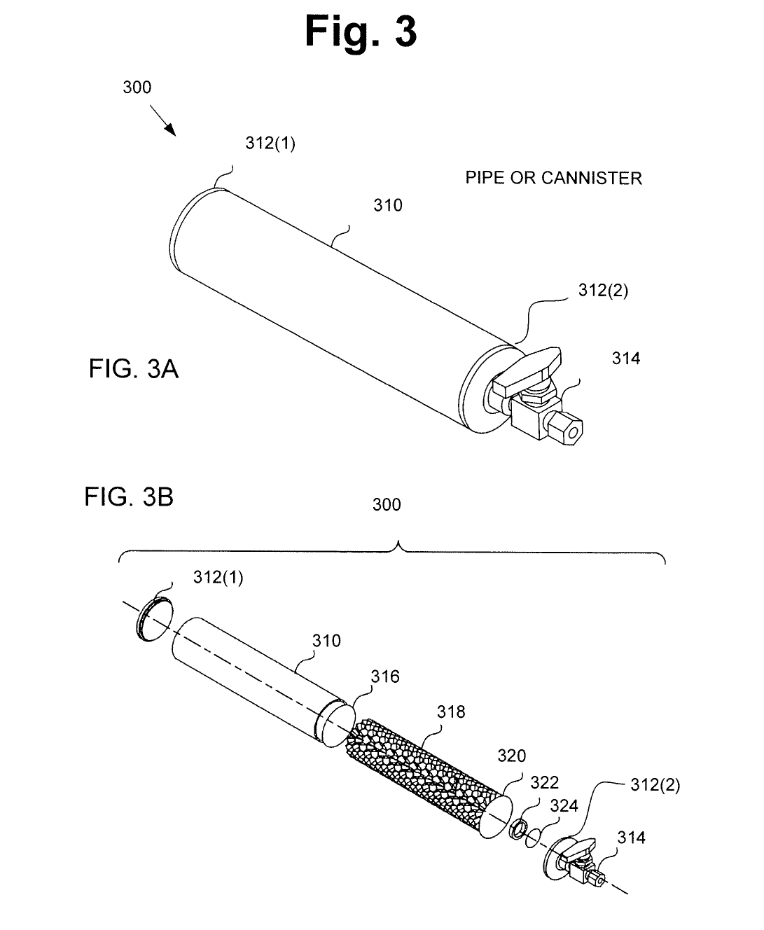

FIG. 3 includes FIGS. 3A and 3B, which together depict a hydrogen storage container, or tank, 300 for storing hydrogen gas collected from electrolysis, in accordance with exemplary embodiments of the present disclosure. Such storage tanks can hold hydrogen gas collected from an electrolysis tank (e.g., tank 200 of FIG. 2) on board a sea going vessel (e.g., vessel 100 of FIG. 1). The hydrogen gas collected from electrolysis can be stored under pressure in tank 300. In exemplary embodiments, the hydrogen is pressurized and stored in liquid form within tank 300.

As shown in FIG. 3A, tank 300 can include a body 310, e.g., a cylindrical member or pipe section. The body 310 can have end plates or caps 312(1)-(2). A suitable valve 314, e.g., a globe or gate valve, can be included for admitting hydrogen into or letting it out of tank 300.

As shown in FIG. 3B by exploded view, tank 300 can include a storage canister 310 and multiple partitions or filters 316, 320. The canister can include a partition element or structure 318 that includes sub volumes suitable for holding materials, e.g., alloys, that can store hydrogen. Gaskets and rings 322, 324, can facilitate sealing of tank 300.

In exemplary embodiments, tank 300 can consist of a relatively long high-pressure pipe (not shown) constructed and stored within the hull of the ship carrying the windmills and electrolysis tank. In exemplary embodiments, such a pipe (storage tank) can be of the order of four to ten inches in diameter. In exemplary embodiments, pipe ends can be threaded and connected with fittings with mating threads. The threads, before being screwed together, can be coated with an epoxy or other suitable sealing compound for greater strength and to seal any possible leaks. As many lengths (e.g., standard sections) of such pipe as desired can be stored in/on the ship so that the total volume of storage could be as large as desired, e.g., the length of storage pipe could be on the order of miles.

Before storing the hydrogen in a suitable container (e.g., storage tank or pipe 300), the container is preferably evacuated to remove all oxygen for safety. Mechanical pumps can be used to reduce the pressure to usefully low pressure, e.g., a magnitude of ten to the minus three millimeters of mercury. This should be sufficient to remove the danger of an explosion. Hydrogen can then be pumped in to the container/tank to a pressure on the order of several atmospheres a tremendous amount of energy will have been stored.

Exemplary embodiments of storage containers can include a hydrogen adsorbent material such as disclosed in U.S. Pat. No. 7,431,151, the entire contents of which are incorporated herein by reference. Further, suitable storage tanks can include one or more heat exchangers such as disclosed in U.S. Pat. No. 7,326,281, the entire contents of which are incorporated herein by reference.

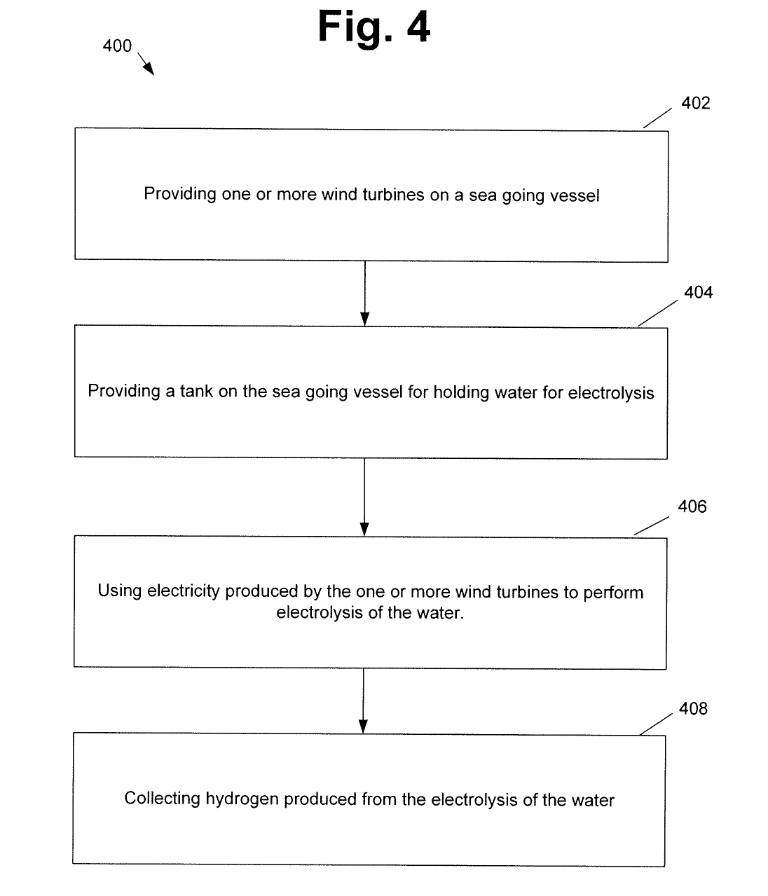

FIG. 4 depicts a block diagram of a method 400 of converting wind energy or power to hydrogen fuel, in accordance with exemplary embodiments of the present disclosure.

For method 400, one or more wind mills or wind machines, e.g., machines 102 of FIG. 1, can be provided to a sea going vessel or ship, as described at 402. Such wind machines can be located on a deck of the ship and be exposed to the wind. A tank, e.g., tank 200 of FIG. 2, can be provided to the ship or vessel for holding water during an electrolysis process, as described at 404. The tank can include one or more pairs of electrolysis plates for splitting water into oxygen and hydrogen.

Continuing with the description of method 400, electricity produced by the one or more wind machines can be used to perform electrolysis, as described at 406, on the water, e.g., sea water, in the tank. Hydrogen can be produced by the electrolysis process and collected, as described at 408. The resulting hydrogen can be stored and subsequently used as desired, e.g., as described previously.

Thus, embodiments of the present disclosure can be suitable for “mining” of oceanic winds. A result of such is that hydrogen quantities can be provided for various application such as for hydrogen distribution networks and hydrogen filling stations for fuel cells use in hybrid and/or hydrogen automobiles. In other applications, large power plants can be constructed that would use hydrogen for heat to produce steam. With sufficient ships supplying hydrogen to a power plant, the size of such a plant can be scaled as desired. The hydrogen that is harvested can be used for many different applications.

Moreover, operation of embodiments of the present disclosure can conceivably produce sufficient hydrogen from the mining from oceanic (e.g., Atlantic) winds to drastically reduce or ameliorate energy shortages around the world. Furthermore this source of hydrogen energy can be environmentally friendly, e.g., considered one hundred percent “Green”.

In addition to attaining ecologically sound generation of hydrogen fuel, embodiments of the present disclosure can be used to mitigate damage and absorb energy from hurricane/typhoons and other storm systems. For example, when a tropical depression, prior to hurricane strength, is believed to be destined for populated land, e.g., by computer aided weather forecasting, energy from the depression could be drained off so that damage to the land area of concern is minimized. While a full fledged hurricane contains energy in excess of an atomic bomb and it would not be possible to drain off energy to forestall land damage, a hurricane starts off as a tropical depression, increases in intensity to a tropical storm and then goes through phase 1 and potentially phases 2-5 of hurricane intensity. Consequently, it can be possible to sufficiently weaken a tropical depression with a fleet of hydrogen ships so that a hurricane never develops.

One skilled in the art will appreciate that embodiments of the present disclosure, including control algorithms/software/signals for controlling electrolysis, can be implemented in hardware, software, firmware, or any combinations of such, and over one or more networks.

While certain embodiments have been described herein, it will be understood by one skilled in the art that the methods, systems, and apparatus of the present disclosure may be embodied in other specific forms without departing from the spirit thereof.

Accordingly, the embodiments described herein, and as claimed in the attached claims, are to be considered in all respects as illustrative of the present disclosure and not restrictive.

What is claimed is:

1. A wind-to-hydrogen system comprising:
a ship configured and arranged to carry one or more wind machines;
one or more wind machines disposed on the ship and configured and arranged to produce electricity in response to movement of one or more turbine blades;
an electrolysis tank including one or more pairs of cathode and anode electrolysis plates and disposed on the ship, wherein the electrolysis tank is configured and arranged to receive electricity from the one or more wind machines for electrolysis; and
a hydrogen storage system configured and arranged to receive hydrogen from the electrolysis tank and store hydrogen.

2. The system of claim 1, wherein the one or more wind machines comprise one or more vertical-axis wind machines.

3. The system of claim 1, wherein the one or more wind machines comprise one or more horizontal-axis wind machines.

4. The system of claim 1, wherein the one or more wind machines are configured and arranged to produce about 1 Mega Watt of power.

5. The system of claim 1, wherein the ship is a multi-hull ship.

6. The system of claim 5, wherein the ship is a catamaran.

7. The system of claim 1, wherein the electrolysis tank comprises a plurality of cells, each including a pair of electrolysis plates.

8. The system of claim 1, wherein the electrolysis tank comprises an electrolyte.

9. The system of claim 8, wherein the electrolyte comprises sodium chloride.

10. The system of claim 1, wherein the hydrogen storage system comprises a high-pressure pipe with one or more pipe sections.

11. The system of claim 1, wherein the hydrogen storage system comprises an inlet/outlet valve.

12. The claim 1, wherein the hydrogen storage system comprises a partition element.

13. The system of claim 12, wherein the partition element comprises a hydrogen storage alloy.

14. A method of converting wind energy to hydrogen fuel, the method comprising:
providing one or more wind machines to a sea going vessel;
providing a tank to the vessel for holding water during an electrolysis process, wherein the tank includes one or more pairs of electrolysis plates for splitting water into oxygen and hydrogen;
using electricity from the one or more wind machines to perform electrolysis of water in the tank; and
collecting hydrogen produced from the electrolysis of water.

15. The method of claim 14, further comprising supplying water to the tank.

16. The method of claim 15, wherein the water comprises salt water.

17. The method of claim 15, wherein the water comprises fresh water.

18. The method of claim 14, further comprising locating the vessel within a tropical depression to reduce wind severity

19. The method of claim 14, further comprising storing hydrogen in a container.

20. The method of claim 19, further comprising evacuating oxygen from the container prior to storing hydrogen.
